(19) United States
(12) Patent Application Publication
(10) Pub. No.: US 2016/0379283 A1
(43) Pub. Date: Dec. 29, 2016

(54) ANALYSIS OF SOCIAL DATA TO MATCH SUPPLIERS TO USERS

(71) Applicant: International Business Machines Corporation, Armonk, NY (US)

(72) Inventors: Swaminathan Balasubramanian, Troy, MI (US); Mark Bell, Gournay en Bray (FR); Gregory J. Boss, Saginaw, MI (US); Rick A. Hamilton, II, Charlottesville, VA (US)

(21) Appl. No.: 14/753,348

(22) Filed: Jun. 29, 2015

(51) Int. Cl. G06Q 30/06; G06K 9/46; G06K 9/62; G06Q 50/00

(52) U.S. Cl. CPC G06Q 30/0603; G06Q 30/0631; G06Q 30/0611; G06Q 50/01; G06K 9/46; G06K 9/6201

(57) ABSTRACT

In an approach for providing a product recommendation, a processor identifies an image as trending, based on the image exceeding a threshold frequency of occurrence on at least one media platform. A processor analyzes the image to identify a set of one or more elements within the image, wherein at least one element is a product. A processor determines one or more interests of a user. A processor determines that the product is relevant to the user based on the one or more interests of the user corresponding, within a predetermined threshold, to an element of the set of one or more elements within the image. A processor sends a notification that includes at least the product.

### BACKGROUND OF THE INVENTION

The present invention relates generally to the field of data analysis, and more particularly to anticipating likely user interests and matching the user proactively to corresponding suppliers.

Analysis of data is a process of inspecting, cleaning, transforming, and modeling data with the goal of discovering useful information, suggesting conclusions and supporting decision making. Data analysis has multiple facets and approaches, encompassing diverse techniques under a variety of names, in different business, science, and social science domains.

Data mining is a particular data analysis technique that focuses on modeling and knowledge discovery for predictive rather than purely descriptive purposes. Business intelligence covers data analysis that relies heavily on aggregation, focusing on business information. In statistical applications, some people divide data analysis into descriptive statistics, exploratory data analysis (EDA), and confirmatory data analysis (CDA). EDA focuses on discovering new features in the data, and CDA focuses on confirming or rejecting existing hypotheses. Predictive analytics focuses on application of statistical models for predictive forecasting or classification, while text analytics applies statistical, linguistic, and structural techniques to extract and classify information from textual sources, as species of unstructured data. All are varieties of data analysis.

Social media are computer-mediated tools that allow people to create, share, or exchange information, ideas, and pictures/videos in virtual communities and networks. Furthermore, social media depend on mobile and web-based technologies to create highly interactive platforms through which individuals and communities share, co-create, discuss, and modify user-generated content. Social media introduce substantial and pervasive changes to communication between businesses, organizations, communities, and individuals. Social media are different from traditional or industrial media in many ways, including quality, reach, frequency, usability, immediacy, and permanence. Social media operates in a dialogic transmission system (many sources to many receivers). This is in contrast to traditional media that operates under a monologic transmission model (one source to many receivers).

### SUMMARY

Aspects of an embodiment of the present invention disclose a method, computer program product, and computing system for providing a product recommendation. A processor identifies an image as trending, based on the image exceeding a threshold frequency of occurrence on at least one media platform. A processor analyzes the image to identify a set of one or more elements within the image, wherein at least one element is a product. A processor determines one or more interests of a user. A processor determines that the product is relevant to the user based on the one or more interests of the user corresponding, within a predetermined threshold, to an element of the set of one or more elements within the image. A processor sends a notification that includes at least the product.

### BRIEF DESCRIPTION OF THE DRAWINGS

FIG. 1 depicts a block diagram of a computing system, in accordance with an embodiment of the present invention.

FIG. 2 depicts a flowchart of the steps of a matching program, executing within the computing system of FIG. 1, for anticipating likely user interests and matching the user proactively to corresponding suppliers, in accordance with an embodiment of the present invention.

FIG. 3 depicts a block diagram of components of the server and/or the computing device of FIG. 1, in accordance with an embodiment of the present invention.

### DETAILED DESCRIPTION

Currently, the penetration of the Internet into modern consumer society is far reaching. On one hand, the Internet constitutes a rich and complex social environment, which reflects, amplifies, and creates the trends, fashions, and fads that drive consumer demand for all types of goods and services. Meanwhile, the Internet has become a preeminent platform for the marketing, product review, and purchase of many of these goods and services. Embodiments of the present invention provide a systematic link between these two facets by providing an approach for automatically anticipating user interests and matching these interests to corresponding suppliers or service providers in a manner that may provide suppliers or service providers with a competitive advantage.

Websites, news feeds, blogs, Internet forums, and social media platforms provide a continuous flow of data, from which it is possible to identify subjects of rising interest, i.e., trending subjects. In particular, many trending subjects comprise images. In today's society, many people using mobile devices look at these images on social media. Embodiments of the present invention use emerging systems of engagement to deliver new value.

Embodiments of the present invention analyze specific individuals and the images being sent, as well as advice being given by their trusted social networks to influence strategic planning and marketing to smaller segments of groups. Additionally, embodiments of the present invention determine the key social trends that influence a specific consumer, which can be extrapolated back to a larger demographic.

Embodiments of the present invention will now be described in detail with reference to the Figures.

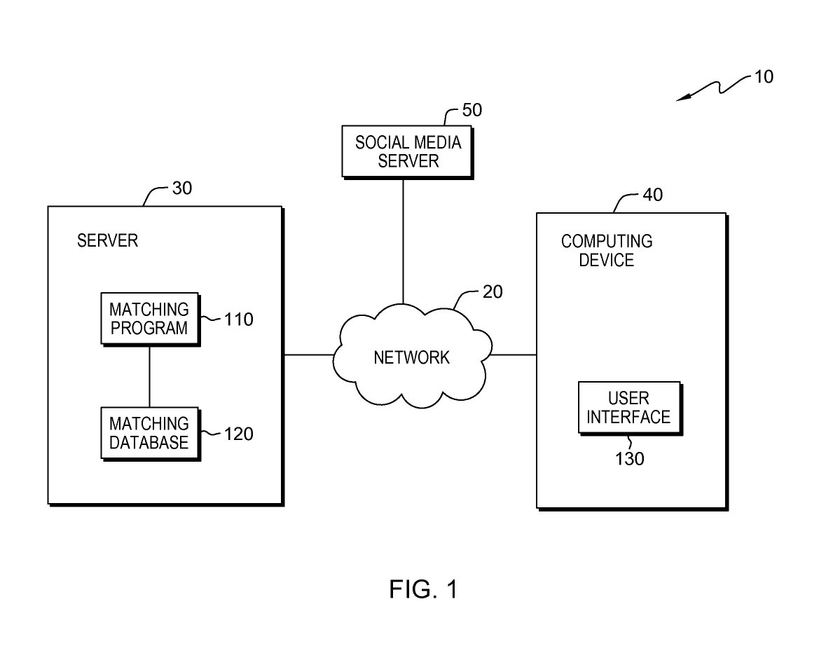

FIG. 1 depicts a block diagram of computing system 10, in accordance with one embodiment of the present invention. FIG. 1 provides an illustration of one embodiment and does not imply any limitations with regard to the environments in which different embodiments may be implemented.

In the depicted embodiment, computing system 10 includes server 30, computing device 40, and social media server 50 interconnected over network 20. Network 20 may be a local area network (LAN), a wide area network (WAN) such as the Internet, a cellular data network, any combination thereof, or any combination of connections and protocols that will support communications between server 30, computing device 40, and social media server 50, in accordance with embodiments of the invention. Network 20 may include wired, wireless, or fiber optic connections. Computing system 10 may include additional computing devices, servers, or other devices not shown.

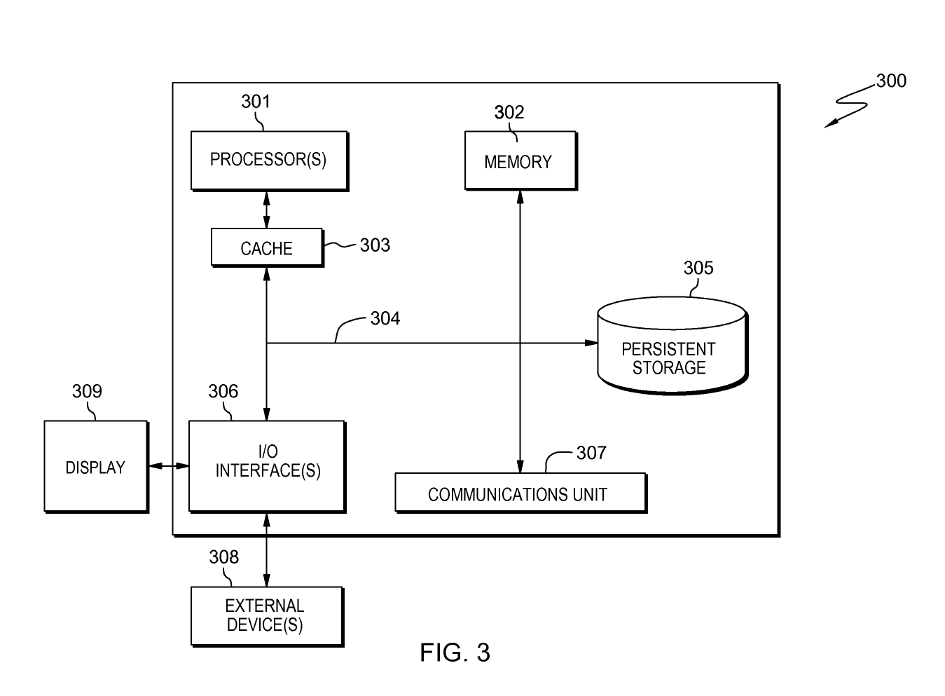

Server 30 may be a management server, a web server, or any other electronic device or computing system capable of processing program instructions and receiving and sending data. In some embodiments, server 30 may be a laptop computer, tablet computer, netbook computer, personal computer (PC), a desktop computer, or any programmable electronic device capable of communicating with computing device 40 and social media server 50 via network 20. In other embodiments, server 30 may represent a server computing system utilizing multiple computers as a server system, such as in a cloud computing environment. In another embodiment, server 30 represents a computing system utilizing clustered computers and components to act as a single pool of seamless resources. In the depicted embodiment, server 30 contains matching program 110 and matching database 120. In other embodiments, server 30 may include matching program 110, matching database 120, and/or other components, as depicted and described in further detail with respect to FIG. 3.

Computing device 40 may be a desktop computer, laptop computer, netbook computer, or tablet computer. In general, computing device 40 may be any electronic device or computing system capable of processing program instructions, sending and receiving data, and communicating with server 30 and social media server 50 via network 20. In the depicted embodiment, computing device 40 contains user interface 130. In other embodiments, computing device 40 may include user interface 130 and/or other components, as depicted and described in further detail with respect to FIG. 3.

Social media server 50 may be a management server, a web server, or any other electronic device or computing system capable of processing program instructions and receiving and sending data. In some embodiments, social media server 50 may be a laptop computer, tablet computer, netbook computer, personal computer (PC), a desktop computer, or any programmable electronic device capable of communicating with server 30 and computing device 40 via network 20. In other embodiments, social media sever 50 may represent a server computing system utilizing multiple computers as a server system, such as in a cloud computing environment. In another embodiment, social media sever 50 represents a computing system utilizing clustered computers and components to act as a single pool of seamless resources. In some embodiments, social media server 50 contains information, such as, for example, trending topics from various social media websites. In other embodiments, social media server 50 may include multiple components, as depicted and described in further detail with respect to FIG. 3.

User interface 130 may be any user interface used to access information from server 30, such as information gathered and/or produced by matching program 110. In some embodiments, user interface 130 may be a generic web browser used to retrieve, present, and negotiate information resources from the Internet. In other embodiments, user interface 130 may be a software program or application that enables a user at computing device 40 to access server 30 over network 20. In the depicted embodiment, user interface 130 resides on computing device 40. In other embodiments, user interface 130, or similar user interfaces, may reside on another computing device, another server, or server 30, provided that user interface 130 is accessible to matching program 110.

Matching program 110 anticipates likely user interests and matches the user proactively to corresponding suppliers. In doing so, matching program 110 receives user interests. Matching program 110 receives image elements. Matching program 110 analyzes user interests and image elements. Matching program 110 determines whether the image elements are relevant to the user. Matching program 110 sends one or more notifications. In the depicted embodiment, matching program 110 resides on server 30. In other embodiments, matching program 110 may reside on another server, computing device, or computing device 40, provided that matching program 110 can access matching database 120 and user interface 130 via network 20.

Matching database 120 may be a repository that may be written to and/or read by matching program 110. In some embodiments, a program (not shown) may allow a user to define various user interests and/or image elements to analyze and store to matching database 120. In other embodiments, matching database 120 may store user interests and/or image elements that were previously analyzed. In some embodiments, matching database 120 is a knowledge base that is governed by an ontology. A knowledge base is a technology used to store complex structured and unstructured information used by a computer system. A knowledge-based system consists of a knowledge base that represents facts and an inference engine that can reason about those facts and use rules and other forms of logic to deduce facts or highlight inconsistencies. In some embodiments, information stored in a knowledge base may include: function categories; descriptions; services; service functions; capabilities and configurations; and WordNet (a lexical database for the English language). An ontology is a formal, explicit specification of a shared abstract simplified view of some selected part of the world, containing the objects, concepts, and other entities that are presumed of interest for some particular purpose and the relationships between them. In the depicted embodiment, matching database 120 resides on server 30. In other embodiments, matching database 120 may reside on another server, computing device, or computing device 40, provided that matching database 120 is accessible to matching program 110 via network 20.

Herein, product may be defined as a product and/or a service.

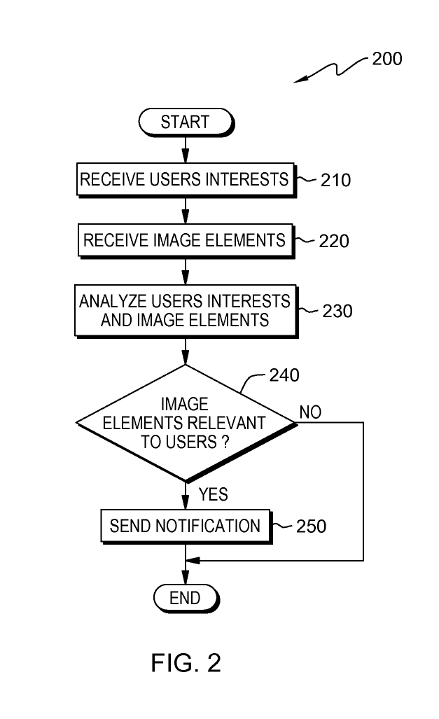

In FIG. 2, environment 200 depicts a flowchart of the steps of a matching program, executing within the computing system of FIG. 1, in accordance with an embodiment of the present invention. Matching program 110 anticipates likely user interests and matches the user proactively to corresponding suppliers.

In step 210, matching program 110 receives user interests. In one embodiment, matching program 110 receives user interests through user interface 130. In other embodiments, matching program 110 receives user interests by retrieving previously stored user interests from matching database 120. In some embodiments, for example, user interests may be gathered from social media profiles for the users, recent searches on general or internal search engines, social media posts, etc.

In step 220, matching program 110 receives image elements. In one embodiment, matching program 110 receives image elements from trending images on social media. In other embodiments, matching program 110 monitors social media networks, such as from social media server 50. In some embodiments, matching program 110 receives image elements of trending images through user interface 130. In other embodiments, matching program 110 receives image elements by retrieving the image elements of trending images from matching database 120.

In one embodiment, images are determined to be trending based on the trending column located on various social media network websites within social media server 50. In other embodiments, images are determined to be trending based on monitoring social media network websites and identifying images that are circulating at a(n) frequency, rate, or amount above a predetermined threshold. For example, a predetermined threshold may be that the image has to circulate more than 10,000 times before matching program 110 would consider the image as trending.

In one embodiment, matching program 110 receives images from trending images on social media. In some embodiments, matching program 110 monitors social media networks, such as from social media server 50, to identify things that are trending. In other embodiments, matching program 110 receives images of trending images through user interface 130. In one embodiment, matching program 110 receives images by retrieving previously stored image elements of trending images from matching database 120. Images may include one or more image elements. In such an embodiment, matching program 110 separates the one or more image elements from the image. The image is broken down into a set of, sometimes, overlapping components (image elements), and each of these components are subjected to the matching and classification process. The image may be identified by various techniques, such as, for example, optical character recognition (OCR), facial recognition system, etc. OCR is the mechanical or electronic conversion of images of typewritten or printed text to machine-encoded text. A facial recognition system is a computer application for automatically identifying or verifying a person from a digital image or a video frame from a video source. Still, in other embodiments, matching program 110 parses through structured or unstructured text when there is only a text version of a trending topic. In some embodiments, matching program 110 parses through structured or unstructured text within an image of a trending topic to obtain valuable information that could further assist in the identification of the image.

Gathering user interests and image elements implies either a collaboration between various Internet platforms, either by explicitly sharing data or by exposing certain data through application programming interfaces (APIs), or more practically, a user side application which captures user interests and image elements. Where neither approach is practicable, matching program 110 operates effectively on the basis of data available within a particular environment, such as matching database 120, without the need to aggregate with other sources. Conversely, a user's email service may constitute a point at which considerable information is visible for aggregation.

Images can be analyzed and categorized into a set of conceptual elements, which are particularly of value when employed alongside natural language processing (NLP) techniques. This process entails using NLP on social media updates from a network of trusted users, and correlating the social media updates to goods or services that the user is actively researching or in the process of purchasing. When a given product or service is found to recur across trending images, it may be assumed that the product or service, at least, has achieved a certain prominence and may benefit from positive association with the core subject of the trending image. Additionally, the product or service may contribute to the popularity of the trending image. As such, it may be expected that at least a latent demand exists for that product or service.

In step 230, matching program 110 analyzes the user interests and the image elements. In some embodiments, the analysis is performed by automatically isolating the image elements of each image, each image element by type (e.g., location, product, person, etc.) and attempting to match each image element against a catalog of image elements, such as image elements found in matching database 120, of the same type. In one embodiment, the catalog is a catalog provided for this specific purpose. In other embodiments, matching program 110 seeks matches through non-specific interfaces, such as through various search engines' image search feature. Description data for matching images can be extracted from image metadata and text analysis of the webpage containing the matching image. In one embodiment, once an image element is classified, the image element is assessed for relevance for all users. In other embodiments, once an image element is classified, the image element is assessed for relevance for a specific subset of users. Users may be classified as a specific subset, for example, based on the user's recent searches and likes, or, for example, various groups to which the users may be members. In some embodiments, once the image element is classified, the image element is stored to matching database 120 for later assessment for relevance for all users or a subset of users.

Where a particular image element cannot be unambiguously mapped to a specific product or service, matching program 110 may be able to classify the particular image element with reference to the basic shape, color, color scheme, etc. Further, valuable information may be derived through matching decorative aspects or other details, in particular with reference to trademark databases. In one embodiment, when a particular image element cannot be identified, matching program 110 stores the image element to matching database 120 as a new, unmatched image element. Unmatched image elements may be flagged for manual identification by an administrator. Once the unmatched image element is stored to matching database 120, it is possible to match future instances of the same image element. Additionally, when the same unmatched image element appears in several trending images, the unmatched image element may be prioritized for manual classification. At this point, an administrator may classify the image element and stores the classified image element to matching database 120. The newly classified image element can now be used by matching program 110 in the same manner as if matching program 110 had made the classification.

In one embodiment, matching program 110 uses a separate classification system for user interests and image elements. In other embodiments, matching program 110 uses a single classification system for both user interests and image elements, so that a direct correlation will be readily apparent. Although any image element may suggest a likelihood of user interest, only a subset of image elements will directly represent products or services. Matching program 110 classifies as many image elements as possible, whether or not they represent a product or service. Generally, each image element is assigned more than one classification. In some embodiments, there is an inheritance of classifications. For example, in the example below, a watch is classified as relevant to golf, not because the watch itself is golf specific, but rather because the watch appears as an image element of an image of a golfer.

In some embodiments, matching program 110 provides a ranking system. In such embodiment, matching program 110 uses the strength of mapping user interests (i.e., if a particular product corresponds to several user interests) and the strength of trend of the image elements to assess the likely interest in each product. A high strength may be caused by, for example, the user is frequently searching particular things, or has indicated that the golfer is the user's favorite athlete. A value of each opportunity is calculated on the basis of the likely interest and the value of the products or services in question. In some embodiments, there is a predetermined threshold value used to dictate the relevancy of the products or services to the user. The value of the opportunity influences the selection of opportunities for presentation to suppliers and/or users. The number of matching classifications between an image element and a user's interests directly influences the ranking.

In decision 240, matching program 110 determines whether the image elements are relevant to the user. In one embodiment, the determination is made based on the one or more interests of the user corresponding, within a predetermined threshold, to an image element. If matching program 110 determines that the image elements are not relevant to the user (decision 240, no branch), matching program 110 ends. In some embodiments (not shown), matching program 110 stores image elements that are not relevant to the user to matching database 120 for further analysis. If matching program 110 determines that the image elements are relevant to the user (decision 240, yes branch), matching program 110 sends one or more notifications (step 250).

In step 250, matching program 110 sends one or more notifications. In one embodiment, matching program 110 sends a notification of the opportunity to a preferred supplier of the particular product or service represented in the image. In other embodiments, matching program 110 sends a notification to the user an offer to buy the product or service represented in the image. In some embodiments, matching program 110 sends a notification to other interested parties, such as individuals represented in the images, owners of registered trademarks, manufacturers of identified goods, etc., to, for example, help the other interested parties assess the value of marketing efforts. Still, in other embodiments, matching program 110 sends a notification to a preferred supplier, a user, and/or other interested parties, in any combination. In one embodiment, matching program 110 sends a textual notification. In other embodiments, matching program 110 sends a notification that includes the initial image or images. In some embodiments, matching program 110 sends a notification that includes text and one or more images.

An example of an embodiment of the present invention is as follows: (1) A user plays golf and follows professional golf on social media. The user has also been browsing for a new watch, which is evident in the user's search history. (2) Player X has just won a major championship, and various images of Player X's triumph start trending on social media. (3) Matching program 110 captures and analyzes the trending images. Matching program 110 identifies Player X as a professional golfer. Matching program 110 also identifies the Player X's brand B watch and brand C cap. (4) The image is assessed as being of potential relevance to the user on the basis of his known interest in golf. A supplier of brand C golf clubs may be offered the opportunity to send the user a request to purchase the brand C golf clubs on the off chance that the user is interested in a new set of golf clubs and would be influenced in choice by Player X's recent success. Furthermore, a supplier of brand B watches is offered the opportunity to send the user a request to purchase a brand B watch on the basis that the user is known to be looking for a new watch and may be influenced to choose a brand B watch because of its association with the rising star. This second opportunity is assessed as of higher value, in view of the user's stronger interest in watches. (5) The supplier of brand B watches sends the image of Player X wearing the brand B watch to the user, with an offer to buy the same watch at an attractive price.

FIG. 3 depicts computer system 300, which is an example of a system that includes components of server 30 and/or computing device 40. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307. Matching program 110 and matching database 120 may be downloaded to persistent storage 305 of server 30 through communications unit 307 of server 30. User interface 130 may be downloaded to persistent storage 305 of computing device 40 through communications unit 307 of computing device 40.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., matching program 110 and matching database 120, can be stored on such portable computer readable storage media and can be loaded onto persistent storage 305 of server 30 via I/O interface(s) 306 of server 30. Software and data used to practice embodiments of the present invention, e.g., user interface 130, can be stored on such portable computer readable storage media and can be loaded onto persistent storage 305 of computing device 40 via I/O interface(s) 306 of computing device 40. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing a product recommendation, the method comprising:
identifying, by one or more processors, an image as trending, based on the image exceeding a threshold frequency of occurrence on at least one media platform;
analyzing, by one or more processors, the image to identify a set of one or more elements within the image, wherein at least one element is a product;
determining, by one or more processors, one or more interests of a user;
determining, by one or more processors, that the product is relevant to the user based on the one or more interests of the user corresponding, within a predetermined threshold, to an element of the set of one or more elements within the image; and
sending, by one or more processors, a notification that includes at least the product.

2. The method of claim 1, wherein an element of the set of one or more elements within the image is a particular person;
wherein the one or more interests of the user include at least the particular person; and
wherein determining that the product is relevant to the user comprises determining, by one or more processors, that the product is relevant to the user based on the one or more interests of the user including the particular person.

3. The method of claim 1, wherein sending the notification that includes at least the product comprises:
sending, by one or more processors, to the user an offer to purchase the product.

4. The method of claim 1, wherein sending the notification that includes at least the product comprises:
sending, by one or more processors, the notification to a supplier of the product, wherein the notification indicates at least the user.

5. The method of claim 1, wherein determining the one or more interests of the user comprises:
monitoring, by one or more processors, social media activity by the user; and
determining, by one or more processors, the one or more interests of the user based on the monitored social media activity of the user.

6. The method of claim 1, wherein analyzing the image to identify a set of one or more elements within the image comprises:
isolating, by one or more processors, each element of the set of one or more elements within the image;
matching, by one or more processors, each element of the set of one or more elements within the image against a catalog; and
extracting, by one or more processors, description data for each matched element of the set of one or more elements within the image.

7. The method of claim 1, wherein the product is a service.

8. A computer program product for providing a product recommendation, the computer program product comprising:
one or more computer readable storage media and program instructions stored on the one or more computer readable storage media, the program instructions comprising:
program instructions to identity an image as trending, based on the image exceeding a threshold frequency of occurrence on at least one media platform;
program instructions to analyze the image to identify a set of one or more elements within the image, wherein at least one element is a product;
program instructions to determine one or more interests of a user;
program instructions to determine that the product is relevant to the user based on the one or more interests of the user corresponding, within a predetermined threshold, to an element of the set of one or more elements within the image; and
program instructions to send a notification that includes at least the product.

9. The computer program product of claim 8, wherein an element of the set of one or more elements within the image is a particular person;
wherein the one or more interests of the user include at least the particular person; and
wherein determining that the product is relevant to the user comprises determining, by one or more processors, that the product is relevant to the user based on the one or more interests of the user including the particular person.

10. The computer program product of claim 8, wherein program instructions to send the notification that includes at least the product comprise:
program instructions to send to the user an offer to purchase the product.

11. The computer program product of claim 8, wherein program instructions to send the notification that includes at least the product comprise:
program instructions to send the notification to a supplier of the product, wherein the notification indicates at least the user.

12. The computer program product of claim 8, wherein program instructions to determine the one or more interests of the user comprise:
program instructions to monitor social media activity by the user; and
program instructions to determine the one or more interests of the user based on the monitored social media activity of the user.

13. The computer program product of claim 8, wherein program instructions to analyze the image to identify a set of one or more elements within the image comprise:
program instructions to isolate each element of the set of one or more elements within the image;
program instructions to match each element of the set of one or more elements within the image against a catalog; and
program instructions to extract description data for each matched element of the set of one or more elements within the image.

14. The computer program product of claim 8, wherein the product is a service.

15. A computer system for providing a product recommendation, the computer system comprising:
one or more computer processors, one or more computer readable storage media, and program instructions stored on the computer readable storage media for execution by at least one of the one or more processors, the program instructions comprising:
program instructions to identity an image as trending, based on the image exceeding a threshold frequency of occurrence on at least one media platform;
program instructions to analyze the image to identify a set of one or more elements within the image, wherein at least one element is a product;
program instructions to determine one or more interests of a user;
program instructions to determine that the product is relevant to the user based on the one or more interests of the user corresponding, within a predetermined threshold, to an element of the set of one or more elements within the image; and
program instructions to send a notification that includes at least the product.

16. The computer system of claim 15, wherein an element of the set of one or more elements within the image is a particular person;
wherein the one or more interests of the user include at least the particular person; and
wherein determining that the product is relevant to the user comprises determining, by one or more processors, that the product is relevant to the user based on the one or more interests of the user including the particular person.

17. The computer system of claim 15, wherein program instructions to send the notification that includes at least the product comprise:
program instructions to send to the user an offer to purchase the product.

18. The computer system of claim 15, wherein program instructions to send the notification that includes at least the product comprise:
program instructions to send the notification to a supplier of the product, wherein the notification indicates at least the user.

19. The computer system of claim 15, wherein program instructions to determine the one or more interests of the user comprise:
program instructions to monitor social media activity by the user; and
program instructions to determine the one or more interests of the user based on the monitored social media activity of the user.

20. The computer system of claim 15, wherein program instructions to analyze the image to identify a set of one or more elements within the image comprise:
program instructions to isolate each element of the set of one or more elements within the image;
program instructions to match each element of the set of one or more elements within the image against a catalog; and
program instructions to extract description data for each matched element of the set of one or more elements within the image.
